(19) United States
(12) Patent Application Publication
(10) Pub. No.: US 2022/0194035 A1
(43) Pub. Date: Jun. 23, 2022

(54) TIRE

(71) Applicant: Continental Reifen Deutschland GmbH, Hannover (DE)

(72) Inventors: Martin Mosko, Rochester Hills, MI (US); Juraj Belobrad, Belusa (SK); Tobias Ehmke, Garbsen (DE)

(73) Assignee: Continental Reifen Deutschland GmbH, Hannover (DE)

(21) Appl. No.: 17/594,335

(22) PCT Filed: Feb. 24, 2020
(86) PCT No.: PCT/EP2020/054729

§ 371 Date: Oct. 12, 2021

(30) Foreign Application Priority Data
Apr. 12, 2019 (DE) 10 2019 205 298.3

(51) Int. Cl. B29D 30/00; B29D 30/48; B60C 15/06; B60C 19/00

(52) U.S. Cl. CPC B29D 30/0061; B29D 30/48; B29D 2030/481; B60C 19/00; B29D 2030/0083; B60C 15/0607

(57) ABSTRACT

The invention relates to a tire (1), the tire (1) being rotatable about an axis of rotation (2) in a direction of rotation (3), having at least one electromagnetic transmitting and receiving device (4), at least one bead core (5) and at least one apex (6), wherein the at least one apex (6) is configured from a first homogeneous rubber material (7) and from a second homogeneous rubber material (8), wherein the first homogeneous rubber material (7) is disposed on the at least one bead core (5) and the first homogeneous rubber material (7) in spatial terms is disposed between the at least one bead core (5) and the one second homogeneous rubber material (8), wherein the at least one electromagnetic transmitting and receiving device (4) is disposed within the at least one apex (6).

The invention relates to a tire.

The invention proceeds from a tire, the tire being rotatable about an axis of rotation in a direction of rotation. The tire has at least one electromagnetic transmitting and receiving device, at least one bead core and at least one apex. The at least one apex is configured from a first homogeneous rubber material and from a second homogeneous rubber material. The first homogeneous rubber material is disposed on the at least one bead core and the first homogeneous rubber material in spatial terms is disposed between the at least one bead core and the one second homogeneous rubber material.

In particular, the tire has at least one carcass ply.

The electromagnetic transmitting and receiving device is in particular an RFID device. RFID stands for Radio Frequency Identification and means identification with the aid of electromagnetic waves.

Electromagnetic transmitting and receiving devices for tires are known from the prior art. For example, an electromagnetic transmitting and receiving device for a tire is disclosed in EP2223814B1.

In the tires known from the prior art with electromagnetic transmitting and receiving devices, the disposal of the electromagnetic transmitting and receiving device could be associated with non-optimal conditions for the operation of the electromagnetic transmitting and receiving device.

The invention is therefore based on the object of providing a tire having an electromagnetic transmitting and receiving device, in the case of which an operation of the electromagnetic transmitting and receiving device within the tire is improved.

The object according to the invention is achieved in that the at least one electromagnetic transmitting and receiving device is disposed within the at least one apex.

Due to the fact according to the invention, according to which the at least one electromagnetic transmitting and receiving device is disposed within the at least one apex, the electromagnetic transmitting and receiving device is disposed within a region of the tire which has a material homogeneity. This material homogeneity ensures an improved operation of the electromagnetic transmitting and receiving device compared to the solutions known from the prior art. In addition, no further use of foreign material is required.

The material of the apex has such dielectric properties that an optimal setting of the electromagnetic transmission capability of the electromagnetic transmitting and receiving device can be enabled.

Thus, an improved tire is provided.

The tire is in particular a truck tire, a passenger motor vehicle tire or a bicycle tire or a motorcycle tire.

Further advantageous embodiments of the present invention are the subject matter of the dependent claims.

According to a preferred design embodiment of the present invention, the at least one electromagnetic transmitting and receiving device is disposed completely within the at least one apex.

According to a preferred design embodiment of the present invention, the at least one electromagnetic transmitting and receiving device has an adhesion promoter coating.

Due to the fact according to the invention, according to which the at least one electromagnetic transmitting and receiving device has an adhesion promoter coating, an improved connection of the at least one electromagnetic transmitting and receiving device within the apex can be ensured.

According to a next preferred design embodiment of the present invention, the at least one electromagnetic transmitting and receiving device has an information storage component and at least one antenna, wherein the at least one antenna is incorporated in a yarn or the at least one antenna and the information storage component are incorporated in a yarn. In particular, the at least one antenna is woven or spun into the yarn. Incorporation by spinning or by weaving are special embodiments of the introduction. The yarn is in particular configured from a plastics material or from a liquid crystal polymer.

The fact according to the invention, according to which the at least one electromagnetic transmitting and receiving device has an information storage component and at least one antenna, wherein the at least one antenna is incorporated in a yarn, provides a construction of such type that takes up less space within a tire than is the case with electromagnetic transmitting and receiving devices known from the prior art. Because the electromagnetic transmitting and receiving device takes up less space inside the tire, the probability of an undesired interaction with the tire is reduced.

According to a next preferred design embodiment of the present invention, the at least one electromagnetic transmitting and receiving device is disposed completely within the second homogeneous rubber material.

The at least one electromagnetic transmitting and receiving device is in particular completely surrounded by the second homogeneous rubber material.

According to a next preferred design embodiment of the present invention, a first spacing between a first surface point of the at least one electromagnetic transmitting and receiving device and a first surface point of the first homogeneous rubber material is at least 5 mm. The first surface point of the at least one electromagnetic transmitting and receiving device and the first surface point of the first homogeneous rubber material in spatial terms are the closest surface points of the at least one electromagnetic transmitting and receiving device and the first homogeneous rubber material.

Due to the fact according to the invention, according to which a first spacing between a first surface point of the at least one electromagnetic transmitting and receiving device and a first surface point of the first homogeneous rubber material is at least 5 mm, wherein the first surface point of the at least one electromagnetic transmitting and receiving device and the first surface point of the first homogeneous rubber material in spatial terms are the closest surface points of the at least one electromagnetic transmitting and receiving device and the first homogeneous rubber material, a mechanical protection of the at least one electromagnetic transmitting and receiving device is ensured and it is ensured that the at least one electromagnetic transmitting and receiving device is arranged within a homogeneous rubber environment.

According to a next preferred design embodiment of the present invention, the at least one electromagnetic transmitting and receiving device is disposed completely within the first homogeneous rubber material.

The at least one electromagnetic transmitting and receiving device is in particular completely surrounded by the first homogeneous rubber material.

According to a next preferred design embodiment of the present invention, a second spacing between a second surface point of the at least one electromagnetic transmitting and receiving device and a first surface point of the second homogeneous rubber material is at least 5 mm. The second surface point of the at least one electromagnetic transmitting and receiving device and the first surface point of the second homogeneous rubber material in spatial terms are the closest surface points of the at least one electromagnetic transmitting and receiving device and the second homogeneous rubber material.

Due to the fact according to the invention, according to which a second spacing between a second surface point of the at least one electromagnetic transmitting and receiving device and a first surface point of the second homogeneous rubber material is at least 5 mm, wherein the second surface point of the at least one electromagnetic transmitting and receiving device and the first surface point of the second homogeneous rubber material in spatial terms are the closest surface points of the at least one electromagnetic transmitting and receiving device and the second homogeneous rubber material, a mechanical protection of the at least one electromagnetic transmitting and receiving device is ensured and it is ensured that the at least one electromagnetic transmitting and receiving device is arranged within a homogeneous rubber environment.

According to a next preferred design embodiment of the present invention, a third spacing between a third surface point of the at least one electromagnetic transmitting and receiving device and an end point of a carcass ply of the tire is at least 10 mm. The third surface point of the at least one electromagnetic transmitting and receiving device and the end point of the carcass ply of the tire in spatial terms are the closest surface points of the at least one electromagnetic transmitting and receiving device and the carcass ply of the tire.

Thus, a minimum spacing between the at least one electromagnetic transmitting and receiving device and the carcass ply is in particular maintained. As a result, the at least one electromagnetic transmitting and receiving device is hardly electromagnetically shielded. The carcass ply is the carcass ply that in spatial terms is closest to the apex.

According to a next preferred design embodiment of the present invention, a third spacing with a positive component in the radial direction between a third surface point of the at least one electromagnetic transmitting and receiving device and an end point of a carcass ply of the tire is at least 10 mm. Thus, proceeding from the axis of rotation, the electromagnetic transmitting and receiving device in the radial direction lies further away from the axis of rotation than the end point of the carcass ply. As a result, electromagnetic shielding of the electromagnetic transmitting and receiving device by the carcass ply is largely avoided.

Positive component means that the direction points away from the axis of rotation.

The radial direction points orthogonally away from the axis of rotation.

According to a next preferred design embodiment of the present invention, a fourth spacing between a fourth surface point of the at least one electromagnetic transmitting and receiving device and an end point of a bead reinforcement of the tire is at least 10 mm. The fourth surface point of the at least one electromagnetic transmitting and receiving device and the end point of the bead reinforcement of the tire in spatial terms are the closest surface points of the at least one electromagnetic transmitting and receiving device and the bead reinforcement of the tire.

Thus, a minimum spacing between the at least one electromagnetic transmitting and receiving device and the bead reinforcement is in particular maintained. As a result, the at least one electromagnetic transmitting and receiving device is barely electromagnetically shielded. The bead reinforcement is the bead reinforcement that in spatial terms is closest to the apex.

According to a next preferred design embodiment of the present invention, a fourth spacing with a positive component in the radial direction between a fourth surface point of the at least one electromagnetic transmitting and receiving device and an end point of a bead reinforcement of the tire is at least 10 mm.

Thus, proceeding from the axis of rotation, the electromagnetic transmitting and receiving device in the radial direction lies further away from the axis of rotation than the end point of the bead reinforcement. As a result, electromagnetic shielding of the electromagnetic transmitting and receiving device by the bead reinforcement is largely avoided.

Positive component means that the direction points away from the axis of rotation.

The radial direction points orthogonally away from the axis of rotation.

Further features, advantages and details, to which the scope of the invention is not limited however, will now be described in more detail with reference to the drawings.

In the figures:

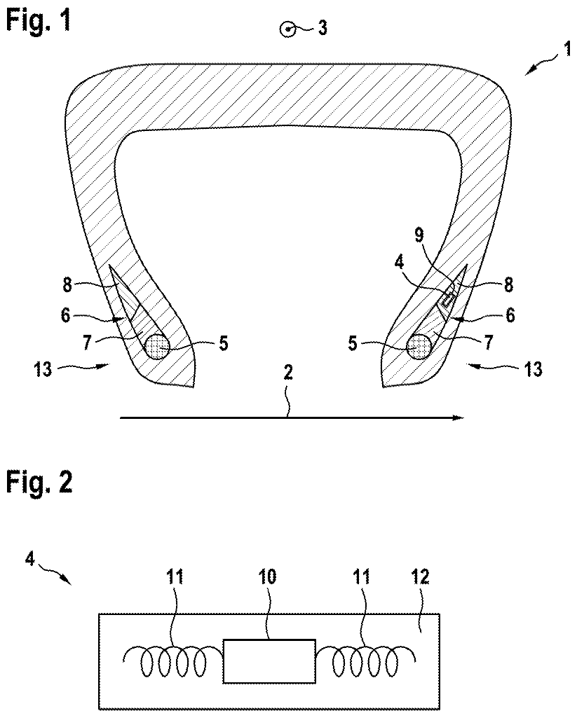

FIG. 1: shows a schematic illustration of a tire according to the invention in a radial sectional view;

FIG. 2: shows a schematic illustration of an electromagnetic transmitting and receiving device according to the invention for disposal in a tire according to the invention;

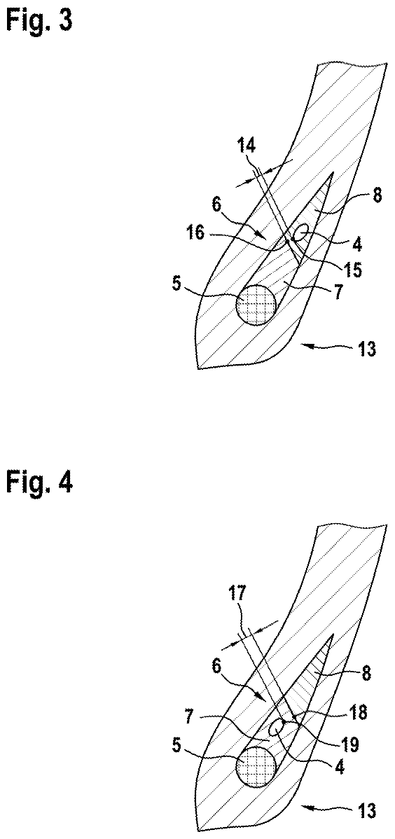

FIG. 3: shows a schematic illustration of a bead area of a tire according to the invention;

FIG. 4 shows a schematic representation of a bead region of a tire according to the invention and according to one embodiment;

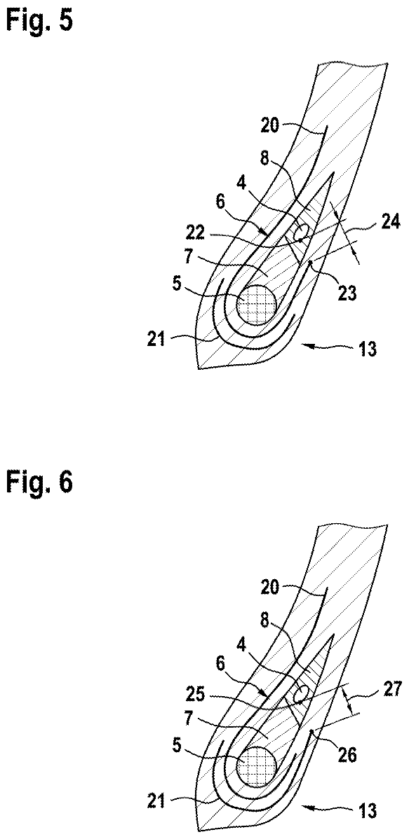

FIG. 5 shows a schematic illustration of a bead region of a tire according to the invention and according to a further embodiment;

FIG. 6 shows a schematic illustration of a bead region of a tire according to the invention and according to a further embodiment.

A tire 1 according to the invention is schematically shown in a radial sectional view in FIG. 1. The tire 1 can be rotated about an axis of rotation 2 in a direction of rotation 3.

The tire 1 has at least one electromagnetic transmitting and receiving device 4, at least one bead core 5 and at least one apex 6.

The at least one bead core 5 is disposed in a bead region 13 of the tire 1.

The at least one apex 6 is configured from a first homogeneous rubber material 7 and from a second homogeneous rubber material 8. The first homogeneous rubber material 7 is disposed on the at least one bead core 5, and the first homogeneous rubber material 7 is spatially disposed between the at least one bead core 5 and the one second homogeneous rubber material 8.

The at least one electromagnetic transmitting and receiving device 4 is disposed within the at least one apex 6.

According to the embodiment of the invention schematically shown in FIG. 1, the at least one electromagnetic transmitting and receiving device 4 has an adhesion promoter coating 9.

An electromagnetic transmitting and receiving device 4 according to the invention for disposal in a tire 1 according to the invention is schematically shown in FIG. 2. According to the illustration in FIG. 2, the at least one electromagnetic transmitting and receiving device 4 has an information storage component 10 and two antennas 11.

The two antennas 11 and the information storage component 10 are incorporated in a yarn 12.

A bead region 13 of a tire 1 according to the invention is schematically illustrated in FIG. 3. According to the illustration in FIG. 3, the at least one electromagnetic transmitting and receiving device 4 is disposed completely within the second homogeneous rubber material 8.

According to the embodiment of the invention schematically shown in FIG. 3, a first spacing 14 between a first surface point 15 of the at least one electromagnetic transmitting and receiving device 4 and a first surface point 16 of the first homogeneous rubber material 7 is at least 5

MM.

The first surface point 15 of the at least one electromagnetic transmitting and receiving device 4 and the first surface point 16 of the first homogeneous rubber material 7 in spatial terms are the closest surface points 15, 16 of the at least one electromagnetic transmitting and receiving device 4 and the first homogeneous rubber material 7.

A bead region 13 of a tire 1 according to the invention and according to one embodiment is schematically shown in FIG. 4. According to the illustration in FIG. 4, the at least one electromagnetic transmitting and receiving device 4 is disposed completely within the first homogeneous rubber material 7.

According to the embodiment of the invention schematically shown in FIG. 4, a second spacing 17 between a second surface point 19 of the at least one electromagnetic transmitting and receiving device 4 and a first surface point 18 of the second homogeneous rubber material 8 is at least 5 mm.

The second surface point 19 of the at least one electromagnetic transmitting and receiving device 4 and the first surface point 18 of the second homogeneous rubber material 8 in spatial terms are the closest surface points 19, 18 of the at least one electromagnetic transmitting and receiving device 4 and the second homogeneous rubber material 8.

A bead region 13 of a tire 1 according to the invention and according to a further embodiment is schematically illustrated in FIG. 5. According to the illustration in FIG. 5, the at least one electromagnetic transmitting and receiving device 4 is disposed completely within the second homogeneous rubber material 8.

According to the embodiment of the invention schematically shown in FIG. 5, the tire 1 has a carcass ply 20 and a bead reinforcement 21. A third spacing 24 between a third surface point 22 of the at least one electromagnetic transmitting and receiving device 4 and an end point 23 of a carcass ply 20 of the tire 1 is at least 10 mm. The third surface point 22 of the at least one electromagnetic transmitting and receiving device 4 and the end point 23 of the carcass ply 20 of the tire 1 in spatial terms are the closest surface points 22, 23 of the at least one electromagnetic transmitting and receiving device 4 and the carcass ply 20 of the tire 1.

According to the illustration in FIG. 5, the carcass ply 20 extends closer to the at least one electromagnetic transmitting and receiving device 4 than the bead reinforcement 21.

A bead region 13 of a tire 1 according to the invention and according to a further embodiment is schematically illustrated in FIG. 6. According to the illustration in FIG. 6, the at least one electromagnetic transmitting and receiving device 4 is disposed completely within the second homogeneous rubber material 8.

According to the embodiment of the invention schematically shown in FIG. 6, the tire 1 has a carcass ply 20 and a bead reinforcement 21. A fourth spacing 27 between a fourth surface point 25 of the at least one electromagnetic transmitting and receiving device 4 and an end point 26 of a bead reinforcement 21 of the tire 1 is at least 10 mm. The fourth surface point 25 of the at least one electromagnetic transmitting and receiving device 4 and the end point 26 of the bead reinforcement 21 of the tire 1 in spatial terms are the closest surface points 25, 26 of the at least one electromagnetic transmitting and receiving device 4 and the bead reinforcement 21 of the tire 1.

According to the illustration in FIG. 6, the bead reinforcement 21 extends closer to the at least one electromagnetic transmitting and receiving device 4 than the carcass ply 20.

### LIST OF REFERENCE SIGNS

### Part of the Description

1 Electromagnetic transmitting and receiving device
2 Axis of rotation
3 Direction of rotation
4 Electromagnetic transmitting and receiving device
5 Bead core
6 Apex
7 First homogeneous rubber material
8 Second homogeneous rubber material
9 Adhesion promoter coating
10 Information storage component
11 Antenna
12 Yarn
13 Bead region
14 First spacing
15 First surface point of the at least one electromagnetic transmitting and receiving device
16 First surface point of the first homogeneous rubber material
17 Second spacing
18 First surface point of the second homogeneous rubber material
19 Second surface point of the at least one electromagnetic transmitting and receiving device
20 Carcass ply
21 Bead reinforcement
22 Third surface point of the at least one electromagnetic transmitting and receiving device
23 End point of the carcass ply
24 Third spacing
25 Fourth surface point of the at least one electromagnetic transmitting and receiving device
26 End point of the bead reinforcement
27 Fourth spacing

1.-9. (canceled)

10. A tire rotatable about an axis of rotation in a direction of rotation, comprising at least one electromagnetic transmitting and receiving device, at least one bead core and at least one apex, wherein the at least one apex is configured from a first homogeneous rubber material and from a second homogeneous rubber material, wherein the first homogeneous rubber material is disposed on the at least one bead core and the first homogeneous rubber material in spatial terms is disposed between the at least one bead core and the one second homogeneous rubber material;
wherein the at least one electromagnetic transmitting and receiving device is disposed within the at least one apex; and,
wherein the at least one electromagnetic transmitting and receiving device comprises an information storage component and at least one antenna, wherein the at least one antenna is incorporated in a yarn, or the at least one antenna and the information storage component are incorporated in a yarn.

11. The tire as claimed in claim 10, wherein the at least one electromagnetic transmitting and receiving device has an adhesion promoter coating.

12. The tire as claimed in claim 10, wherein the at least one electromagnetic transmitting and receiving device is disposed completely within the second homogeneous rubber material.

13. The tire as claimed in claim 12, wherein a first spacing between a first surface point of the at least one electromagnetic transmitting and receiving device and a first surface point of the first homogeneous rubber material is at least 5 mm, wherein the first surface point of the at least one electromagnetic transmitting and receiving device and the first surface point of the first homogeneous rubber material in spatial terms are the closest surface points of the at least one electromagnetic transmitting and receiving device and the first homogeneous rubber material.

14. The tire as claimed in claim 10, wherein the at least one electromagnetic transmitting and receiving device is disposed completely within the first homogeneous rubber material.

15. The tire as claimed in claim 14, wherein a second spacing between a second surface point of the at least one electromagnetic transmitting and receiving device and a first surface point of the second homogeneous rubber material is at least 5 mm, wherein the second surface point of the at least one electromagnetic transmitting and receiving device and the first surface point of the second homogeneous rubber material in spatial terms are the closest surface points of the at least one electromagnetic transmitting and receiving device and the second homogeneous rubber material.

16. The tire as claimed in claim 10, wherein a third spacing between a third surface point of the at least one electromagnetic transmitting and receiving device and an end point of a carcass ply of the tire is at least 10 mm, wherein the third surface point of the at least one electromagnetic transmitting and receiving device and the end point of the carcass ply of the tire in spatial terms are the closest surface points of the at least one electromagnetic transmitting and receiving device and the carcass ply of the tire.

17. The tire as claimed in claim 10, wherein a fourth spacing between a fourth surface point of the at least one electromagnetic transmitting and receiving device and an end point of a bead reinforcement of the tire is at least 10 mm wherein the fourth surface point of the at least one electromagnetic transmitting and receiving device and the end point of the bead reinforcement of the tire in spatial terms are the closest surface points of the at least one electromagnetic transmitting and receiving device and the bead reinforcement of the tire.
